(19) United States
(12) Patent Application Publication
(10) Pub. No.: US 2026/0264402 A1
(43) Pub. Date: Sep. 10, 2026

(54) LIQUID DISCHARGE HEAD, LIQUID DISCHARGE HEAD UNIT, AND LIQUID DISCHARGE APPARATUS

(71) Applicant: Takashi KINOKUNI, Tokyo (JP)

(72) Inventor: Takashi KINOKUNI, Tokyo (JP)

(21) Appl. No.: 19/537,594

(22) Filed: Feb. 12, 2026

(30) Foreign Application Priority Data
Mar. 10, 2025 (JP) 2025-037487

(51) Int. Cl. B41J 2/14

(52) U.S. Cl. CPC B41J 2/1433; B41J 2/14233; B41J 2002/14419; B41J 2002/14491; B41J 2202/11; B41J 2202/19

(57) ABSTRACT

A liquid discharge head includes a nozzle plate having a rectangular shape having long sides and short sides; a nozzles array having nozzles to discharge liquid; and a positioning mark. The nozzles in the nozzle array are arrayed in a nozzle array direction oblique to one of the short sides of the nozzle plate. The positioning mark is disposed in a positioning area having a right-angled triangular shape enclosed by the nozzle array, the one of the short sides, and a part of one of the long sides between the one of the short sides and the nozzle array.

### CROSS-REFERENCE TO RELATED APPLICATIONS

This patent application is based on and claims priority pursuant to 35 U.S.C. § 119(a) to Japanese Patent Application No. 2025-037487, filed on Mar. 10, 2025, in the Japan Patent Office, the entire disclosure of which is hereby incorporated by reference herein.

### BACKGROUND

### Technical Field

The present disclosure relates to a liquid discharge head, a liquid discharge head unit, and a liquid discharge apparatus.

### Related Art

As a liquid discharge head mounted on an inkjet image forming apparatus, a liquid discharge head including various types of members, such as a nozzle plate, an individual liquid chamber member, a diaphragm, and a common liquid chamber member, stacked has been known.

### SUMMARY

The present disclosure herein discloses a liquid discharge head includes a nozzle plate having a rectangular shape having long sides and short sides; a nozzles array having nozzles to discharge liquid; and a positioning mark. The nozzles in the nozzle array are arrayed in a nozzle array direction oblique to one of the short sides of the nozzle plate. The positioning mark is disposed in a positioning area having a right-angled triangular shape enclosed by the nozzle array, the one of the short sides, and a part of one of the long sides between the one of the short sides and the nozzle array.

The present disclosure herein discloses a liquid discharge head unit including multiple liquid discharge heads including the liquid discharge head.

The present disclosure herein discloses a liquid discharge apparatus including the liquid discharge head.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating the entire configuration of an inkjet image forming apparatus according to a first embodiment of the present disclosure;

FIG. 2 is a control block diagram of the image forming apparatus according to the first embodiment of the present disclosure;

FIG. 3 is a cross-sectional view of a liquid discharge head according to the first embodiment of the present disclosure;

FIG. 4 is an exploded perspective view illustrating the liquid discharge head according to the first embodiment of the present disclosure, in which a nozzle plate, a liquid chamber member, a diaphragm, and a base member are separated from each other;

FIG. 5 is a plan view of the nozzle plate according to the first embodiment of the present disclosure;

FIG. 6 is a plan view illustrating a preferred arrangement example of positioning marks;

FIG. 7 is a plan view of a nozzle plate according to a second embodiment of the present disclosure;

FIG. 8 is a cross-sectional view of the nozzle plate according to the second embodiment of the present disclosure;

FIG. 9 is a plan view of a nozzle plate according to a third embodiment of the present disclosure;

FIG. 10 is a cross-sectional view of the nozzle plate according to the third embodiment of the present disclosure;

FIG. 11 is an exploded perspective view illustrating the configuration of another liquid discharge head to which the present disclosure can be applied;

FIG. 12 is a schematic diagram illustrating the entire configuration of an electrode manufacturing apparatus to which the present disclosure can be applied; and

FIG. 13 is a plan view of a nozzle plate according to a comparative example of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

The present disclosure will be described below with reference to the accompanying drawings. Note that constituent elements, such as members or constituent components, having the same functions or shapes, are denoted with the same reference signs in the drawings for use in describing the present disclosure and duplicate descriptions thereof will be omitted.

For such a liquid discharge head including multiple stack members, in order to join the stack members together, the stack members are to be positioned accurately. Thus, as a comparative example, a technique has been proposed in which a positioning mark (alignment mark) for positioning between a nozzle plate and a diaphragm is provided to a channel plate as a stack member.

In general, constituent elements, such as nozzles, used for liquid discharging, are often disposed at the center and near the center of a stack member, such as a nozzle plate included in a liquid discharge head. Therefore, for provision of such a positioning mark as above, preferably, the positioning mark is provided to the edge of a stack member, on which any constituent elements are not disposed, such that discharging performance is not adversely affected.

However, in order to provide the positioning mark to the edge of the stack member, a space is to be reserved for the positioning mark at the edge of the stack member, and thus the outer dimensions of the stack member are increased by the space, leading to an increase in the size of the liquid discharge head.

Thus, an object of the present disclosure is to provide a positioning mark without an increase in outer dimensions.

According to the present disclosure, a positioning mark can be provided without an increase in outer dimensions.

### Entire Configuration of Image Forming Apparatus

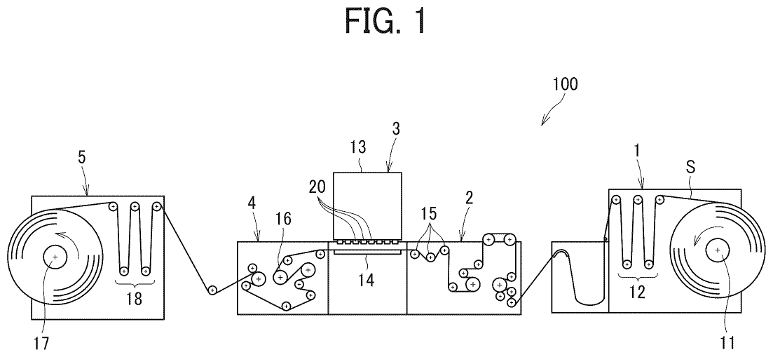

First, an inkjet image forming apparatus will be described, as an exemplary liquid discharge apparatus to which the present disclosure is applied, with reference to FIG. 1.

FIG. 1 is a schematic diagram illustrating the entire configuration of an inkjet image forming apparatus 100 according to a first embodiment of the present disclosure.

As in FIG. 1, the image forming apparatus 100 according to the first embodiment of the present disclosure includes a sheet feeding unit 1, a sheet conveying unit 2, an image forming unit 3, a drying unit 4, and a sheet collecting unit 5.

The sheet feeding unit 1 includes a sheet feeding roller 11 that feeds a sheet S and a tension adjuster 12 that adjusts the tension of the sheet S being fed. The sheet S of a long type is wound around the sheet feeding roller 11 in a roll. In response to rotation of the sheet feeding roller 11, the sheet S is fed by unreeling from the sheet feeding roller 11. The tension adjuster 12 adjusts the tension of the sheet S such that the sheet S is fed at a constant tension. For example, the tension adjuster 12 includes multiple supporting rollers around which the sheet S is stretched, and changes the interval between the supporting rollers to adjust the tension of the sheet S.

The sheet conveying unit 2 includes multiple conveying rollers 15 that conveys, to the image forming unit 3, the sheet S fed from the sheet feeding unit 1. The conveying rollers 15 correspond to an exemplary conveyer that conveys the sheet S. As the conveyer, a conveying belt may be used, instead of the conveying rollers 15. In response to rotation of the conveying rollers 15 with the sheet S stretched around the multiple conveying rollers 15, the sheet S is conveyed to the image forming unit 3.

The image forming unit 3 includes a liquid discharge head unit 13 on which multiple liquid discharge heads 20 is mounted.

In the image forming unit 3, a conveying guide 14 that guides the sheet S being conveyed is located counter to the liquid discharge head unit 13. After conveyance of the sheet S to the image forming unit 3, the conveying guide 14 guides the sheet S and additionally the liquid discharge heads 20 discharge ink to the sheet S to form an image on the sheet S. Note that the configuration of the liquid discharge head unit 13 may be compliant with a so-called line type of liquid discharge head that remains stationary and discharges liquid or a so-called serial type of liquid discharge head that discharges liquid while moving.

The drying unit 4 includes a heating roller 16 as a heater that heats the sheet S. The heating roller 16 is a cylindrical heating member having a heating source, such as a halogen heater, therein. In response to conveyance of the sheet S to the drying unit 4 after formation of an image on the sheet S, the sheet S is heated in contact with the outer circumferential face of the heating roller 16. Thus, a liquid component contained in the ink on the sheet S evaporates, so that the sheet S is dried. As the heater that heats the sheet S, instead of a contact type of heater like the heating roller 16, a non-contact type of heater, such as a warm air generator that blows warm air to the sheet S, may be used.

The sheet collecting unit 5 includes a collecting roller 17 that collects the sheet S and a tension adjuster 18 that adjusts the tension of the sheet S. In response to conveyance of the sheet S to the sheet collecting unit 5, the collecting roller 17 rotating reels in the sheet S in a roll for collection. Like the tension adjuster 12 in the sheet feeding unit 1, the tension adjuster 18 includes multiple supporting rollers around which the sheet S is stretched, and changes the interval between the supporting rollers to adjust the tension of the sheet S. Thus, the collecting roller 17 reels in the sheet S at a constant tension for collection.

### Control Configuration of Image Forming Apparatus

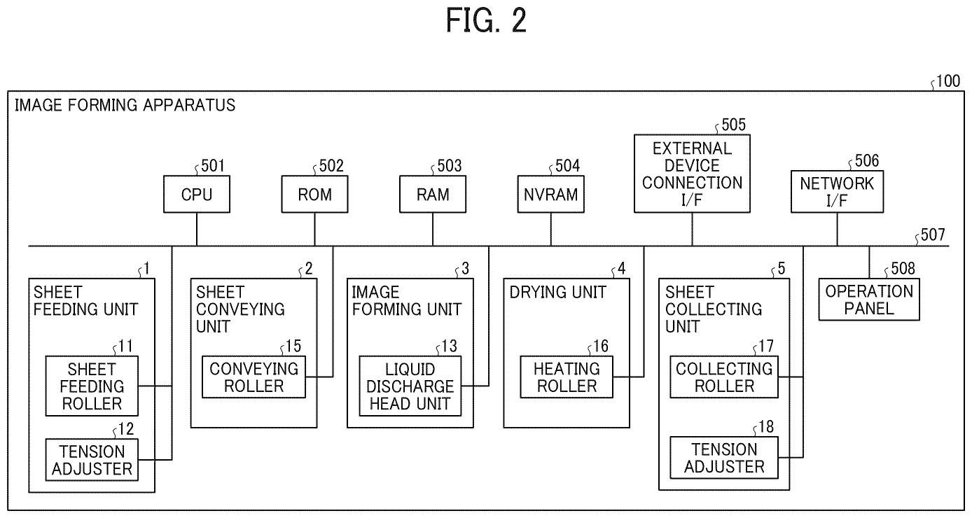

FIG. 2 is a control block diagram of the image forming apparatus 100 according to the first embodiment of the present disclosure.

As in FIG. 2, the image forming apparatus 100 according to the first embodiment of the present disclosure includes a central processing unit (CPU) 501, a read-only memory (ROM) 502, a random access memory (RAM) 503, a non-volatile random access memory (NVRAM) 504, an external device connection interface (I/F) 505, a network I/F 506, a bus line 507, and an operation panel 508.

The CPU 501 serves as a computing unit that controls the entire operation of the image forming apparatus 100. Specifically, the CPU 501 controls the operation of the liquid discharge head unit 13, the respective rotational rates of the sheet feeding roller 11, the collecting roller 17, and the conveying rollers 15, the temperature of the heating roller 16, and the respective tension adjusting operations of the tension adjusters 12 and 18. The ROM 502 serves as a read-only non-volatile storage medium that stores programs for the CPU 501 to operate, such as an initial program loader (IPL). The RAM 503 serves as a volatile storage medium that allows high-speed reading and writing of information, and is used as a working area for the CPU 501 to process information. The NVRAM 504 serves as a non-volatile storage medium that allows reading and writing of information, and stores various types of data, such as setting values and a program for controlling each unit in the image forming apparatus 100. In response to reading of a program stored in the ROM 502 into the RAM 503, the CPU 501 performs computing in accordance with the program loaded in the RAM 503 to control each unit in the image forming apparatus 100. In this case, the CPU 501 uses the setting values stored in the NVRAM 504.

The external device connection I/F 505 is connected to a personal computer (PC) through a universal serial bus (USB) cable for data communication with the PC regarding a control signal and an image to be printed. The network I/F 506 corresponds to an interface for data communication through a communication network, such as the Internet. The bus line 507 includes an address bus and a data bus for electrically connecting the constituent elements, such as the CPU 501.

The operation panel 508 serves as a touch-panel input unit that displays the current set values and selected screen and receives an input from an operator. In response to input of various types of information, such as image information, the rate of sheet conveyance, and the type of the sheet, through the operation panel 508, the CPU 501 controls various types of operations of the image forming apparatus 100, based on the input information.

### Configuration of Liquid Discharge Head

Next, the configuration of a liquid discharge head 20 according to the first embodiment of the present disclosure will be described.

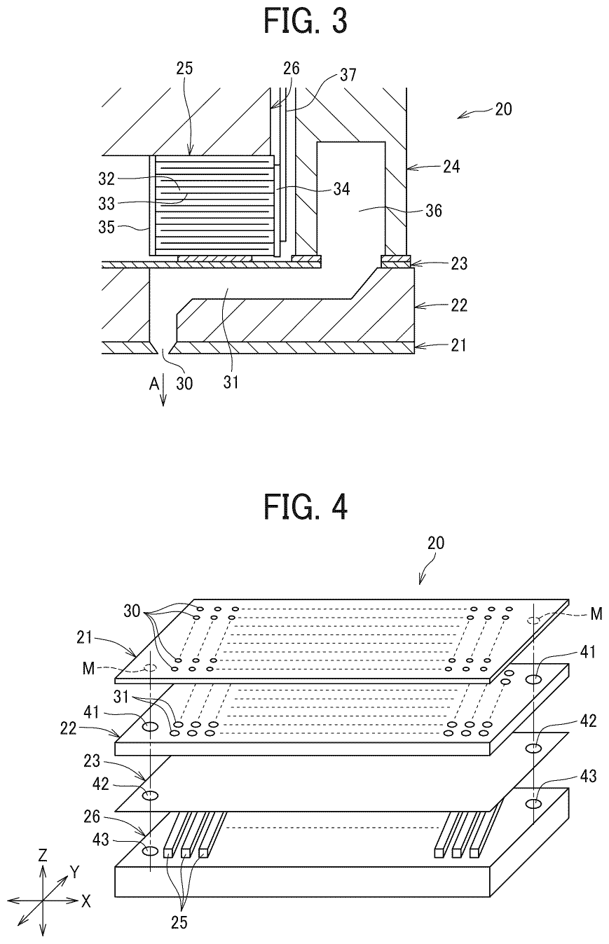

FIG. 3 is a cross-sectional view of the liquid discharge head 20 according to the first embodiment of the present disclosure.

As in FIG. 3, the liquid discharge head 20 according to the first embodiment of the present disclosure includes a nozzle plate 21, a liquid chamber member 22, a diaphragm 23, a common channel member 24, a piezoelectric element 25, and a base member 26. The nozzle plate 21, the liquid chamber member 22, the diaphragm 23, the common channel member 24, the piezoelectric element 25, and the base member 26 correspond to stack members joined in a stack in a liquid discharge direction A in which liquid (ink) is discharged.

The nozzle plate 21 includes a nozzle 30 that discharges liquid. Referring to FIG. 3, although only one nozzle 30 is illustrated, multiple nozzles 30 is disposed side by side over a face facing in the liquid discharge direction A of the nozzle plate 21.

The liquid chamber member 22 includes individual liquid chambers 31 in one-to-one communication with the multiple nozzles 30. The individual liquid chambers 31 are disposed side by side corresponding one-to-one to the nozzles 30.

The common channel member 24 includes a common channel 36 in communication with all the multiple individual liquid chambers 31.

The common channel member 24 has a supply port that is connected thereto and is in communication with the common channel 36, on the side counter to the side on which the common channel 36 is in communication with the individual liquid chambers 31. Thus, supplying liquid through the supply port causes the liquid to be supplied to each individual liquid chamber 31 through the common channel 36.

The diaphragm 23 is a deformable member interposed between the liquid chamber member 22 and the common channel member 24. The diaphragm 23 is joined to the liquid chamber member 22, forming a deformable diaphragmatic wall in which the diaphragm 23 partitions the individual liquid chambers 31. The deformable diaphragmatic wall is provided with the piezoelectric element 25 as an actuator that deforms the diaphragm 23.

The piezoelectric element 25 corresponds to a member displaceable in its stack direction in accordance with a driving waveform applied from a driving circuit (driver IC) and is supported by the base member 26 disposed on the side counter to the side on which the diaphragm 23 is disposed. For example, the piezoelectric element 25 is formed of piezoelectric layers 32 and internal electrode layers 33 alternately stacked, in which each piezoelectric layer 32 is made of lead zirconate titanate (PZT) and has a thickness of 10 to 50 μm and each internal electrode layer 33 is made of silver palladium (AgPd) and is a few micrometers in thickness. An individual electrode 34 and a common electrode 35 are connected to the inner electrode layers 33. A driving circuit is connected to the individual electrode 34 through a flexible wiring member 37.

The driving circuit functions to apply a driving waveform selectively to the piezoelectric element 25 for each individual liquid chamber 31. In response to application of the driving waveform from the driving circuit to the piezoelectric element 25, the piezoelectric element 25 is displaced in its stack direction, so that the diaphragm 23 deforms. Thus, the liquid in the corresponding individual liquid chamber 31 is discharged by pressurization through the nozzle 30.

A case in which the piezoelectric element 25 is used as an actuator that discharges liquid has been exemplified, but such an actuator is not limited to the piezoelectric element 25 and thus may be of a heating type, such as a thermal type in which a heater boils liquid to discharge the liquid through a nozzle, or may be of another type in which electrostatic attraction is generated due to application of voltage to discharge liquid.

Stack members, such as the nozzle plate 21, the liquid chamber member 22, and the diaphragm 23 included in the liquid discharge head 20 described above, are to be positioned accurately for mutual joining in a stack. Thus, as a comparative example, a method for providing a positioning mark has been proposed in order to position such stack members mutually.

However, providing such a positioning mark to a stack member causes the following disadvantages.

### Disadvantages due to Provision of Positioning Mark

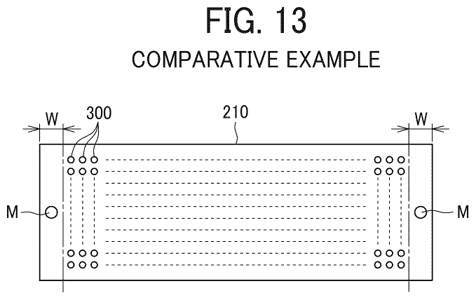

FIG. 13 is a plan view of a nozzle plate 210 according to a comparative example of the present disclosure.

The nozzle plate 210 illustrated in FIG. 13 is provided with positioning marks M for positioning with a member to be joined. Typically, the nozzle plate 210 has multiple nozzles 300 arrayed at its center and near the center, and thus the positioning marks M are to be provided to the edge of the nozzle plate 210 on which no nozzles 300 are arrayed. Like the nozzle plate 210, other stack members to be stacked on the nozzle plate 210 often have constituent elements disposed at their centers and near the centers. Thus, preferably, such positioning marks M are provided to the edges of the stack members.

However, in order to provide a positioning mark to the edge of a stack member, a space is to be reserved for the positioning mark, and thus an increase is made in the outer dimensions of the stack member, leading to an increase in the size of a liquid discharge head. Referring to FIG. 13, according to the comparative example, for example, an increase in lateral width is made by a space W for a positioning mark on each of the left and right sides because the left and right edges are provided with the positioning marks M, whereas the upper and lower edges are provided with no positioning marks. Therefore, in a case where a positioning mark is provided to the edge of a stack member, a liquid discharge head is difficult to reduce in size as a disadvantage. In addition, an increase in the outer dimensions of a stack member causes a decrease in the number of stack members formable from the base material by division, resulting in an increase in manufacturing cost as a disadvantage.

Thus, according to the present disclosure, the following proposed configuration for a liquid discharge head is given in order to provide a positioning mark without an increase in outer dimensions. A feature configuration of the liquid discharge head according to the first embodiment of the present disclosure will be described below.

### Feature Configuration of Liquid Discharge Head

FIG. 4 is an exploded perspective view illustrating the liquid discharge head 20 according to the first embodiment of the present disclosure, in which the nozzle plate 21, the liquid chamber member 22, the diaphragm 23, and the base member 26 are separated from each other.

As in FIG. 4, the nozzle plate 21, the liquid chamber member 22, the diaphragm 23, and the base member 26 as stack members are each formed in a plate-like shape extending in an X direction in the drawing. The X direction, a Y direction, and a Z direction in FIG. 4 indicate the directions of three-dimensional coordinate axes of each stack member according to the first embodiment of the present disclosure. In this case, the X direction indicates the direction parallel to the longitudinal direction of each stack member, and the Y direction indicates the direction orthogonal to the X direction in a case where each stack member is viewed in the Z direction. The Z direction is the direction orthogonal to each of the X and Y directions. Note that the X, Y, and Z directions in other drawings are identical to the X, Y, and Z directions in FIG. 4, respectively.

As in FIG. 4, the nozzle plate 21 is provided with positioning marks M for positioning. On the other hand, the liquid chamber member 22, the diaphragm 23, and the base member 26 to be joined to the nozzle plate 21 are provided with positioning windows 41, 42, and 43 as through holes. The positioning marks M are each a recessed mark, such as a V-shaped groove, provided on the counter face of the nozzle plate 21 to the liquid chamber member 22. Note that the positioning marks M may be each a flat mark or a protruding mark, instead of a recessed mark, provided that the positions of the positioning marks M can be checked. Each of the positioning windows 41,42, and 43 is provided corresponding to one of the positioning marks M. In order to stack the liquid chamber member 22, the diaphragm 23, and the base member 26 in sequence onto the nozzle plate 21, for example, the position of each positioning mark M on the nozzle plate 21 is checked through the corresponding positioning windows 41, 42, and 43 using an optical sensor, so that the members can be joined together due to accurate positioning.

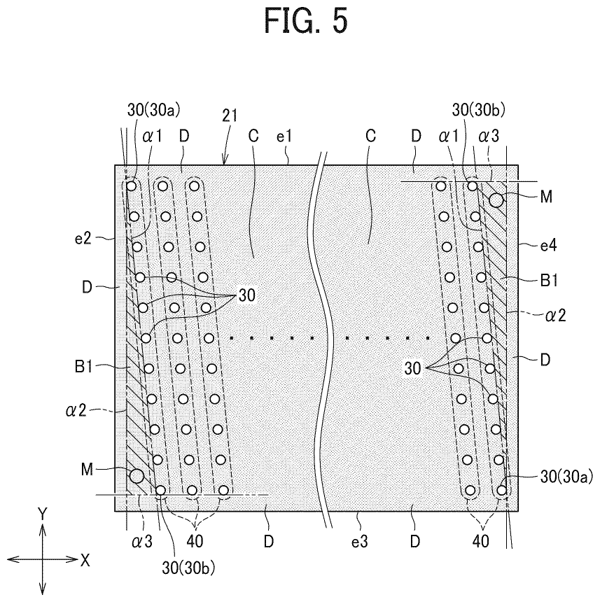

FIG. 5 is a plan view of the nozzle plate 21 according to the first embodiment of the present disclosure.

As in FIG. 5, according to the first embodiment of the present disclosure, the nozzle plate 21 is a rectangular plate-like member having two long sides e1 and e3 and two short sides e2 and e4. The nozzle plate 21 has nozzle arrays 40 disposed obliquely with respect to the short sides e2 and e4, which are outer ends of the nozzle plate 21, in which the nozzle arrays 40 each include multiple nozzles 30 arrayed. Thus, a right-angled triangular free area B1, in which no nozzles 30 are disposed, is formed between the short side e2 and the nozzle array 40 closest to the short side e2 and another right-angled triangular free area B1, in which no nozzles 30 are disposed, is formed between the short side e4 and the nozzle array 40 closest to the short side e4. According to the first embodiment of the present disclosure, the right-angled triangular free areas B1 are each provided with a positioning mark M.

As illustrated in FIG. 5, each right-angled triangular area B1 provided with the positioning mark M corresponds to an area out of a nozzle formation area C in which the nozzles 30 are formed and the edge D of the nozzle plate 21 (edge along the four sides e1 to e4). That is, each right-angled triangular area B1 corresponds to an area surrounded by three tangent lines (straight lines) α1, α2, and α3 in FIG. 5 out of the nozzle formation area C and the edge D. The three tangent lines α1, α2, and α3 forming each right-angled triangular area B1 are defined as follows.

First, the tangent line α1 corresponds to a first tangent line in contact with the multiple nozzles 30 included in the nozzle array 40 closest to the short side e2 or e4 among the multiple nozzle arrays 40 from the side on which the corresponding short side e2 or e4 is located. Next, the tangent line α2 corresponds to a second tangent line that is in contact with the nozzle 30 (30a) closest to the short side e2 or e4 among the multiple nozzles 30 included in the nozzle array 40 closest to the corresponding short side e2 or e4 from the side on which the corresponding short side e2 or e4 is located and is parallel to the corresponding short side e2 or e4. Next, the tangent line α3 corresponds to a third tangent line in contact with the nozzle 30 (30b) farthest from the short side e2 or e4 among the multiple nozzles 30 included in the nozzle array 40 closest to the corresponding short side e2 or e4 from outside the nozzle array 40 and is orthogonal to the corresponding short side e2 or e4. Then, the positioning marks M are provided one-to-one within the areas B1 each surrounded by the three tangent lines α1, α2, and α3. Specifically, as in FIG. 5, in view in the direction orthogonal to the joint face between stack members that include the nozzle plate 21 and are joined, the positioning marks M are each provided within the corresponding right-angled triangular area B1 surrounded by the first tangent line α1, the second tangent line α2, and the third tangent line α3.

As above, according to the first embodiment of the present disclosure, since the positioning marks M are each provided within the corresponding right-angled triangular area B1 out of the nozzle formation area C and the edge D of the nozzle plate 21, the areas B1 as free spaces can be effectively used as arrangement spaces for the positioning marks M. Thus, the positioning marks M can be provided out of the edge D of the nozzle plate 21 without any adverse effect on discharging performance, so that an increase in the outer dimensions of the nozzle plate 21 can be avoided.

Therefore, due to the above-described configuration according to the first embodiment of the present disclosure, a reduction can be made in the size of the liquid discharge head 20. In addition, since the positioning marks M can be provided without an increase in the outer dimensions of the nozzle plate 21, the nozzle plate 21 can be efficiently cut out from the base material. Therefore, due to the above-described configuration according to the first embodiment of the present disclosure, a large number of nozzle plates 21 can be obtained, leading to a reduction in manufacturing cost.

Note that the expression “positioning marks M are each provided within the corresponding area B1” means that at least part of each of the positioning marks M is disposed overlapping the corresponding area B1 in view in the direction orthogonal to the joint face and thus does not necessarily mean that the positioning marks M are each flush with the corresponding area B1. In addition, the arrangement of each of the positioning marks M can be changed as appropriate, provided that the positioning marks M are each provided within the corresponding right-angled triangular area B1. However, in order to effectively prevent an increase in the outer dimensions of a stack member, preferably, the positioning marks M are each provided without protruding from the corresponding right-angled triangular area B1 (the entirety of each of the positioning marks M is provided within the corresponding area B1). The number of positioning marks M is not limited to two and thus may be one or three or more.

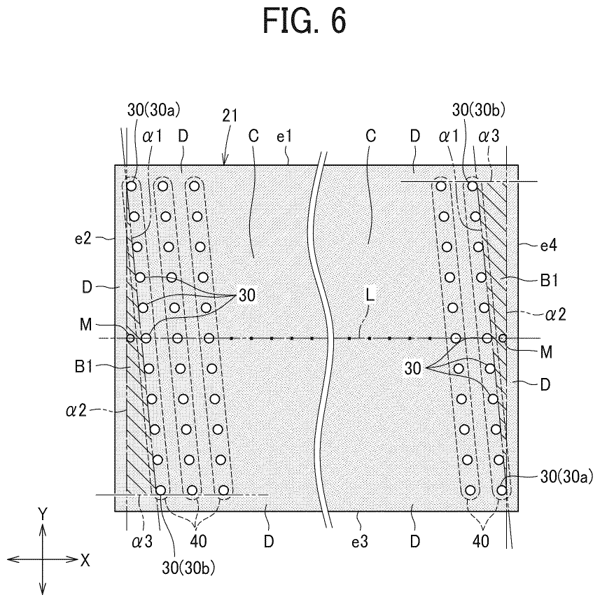

In particular, for provision of two positioning marks M separately from each other in the longitudinal direction of the nozzle plate 21 (close to the short sides e2 and e4, respectively), as in the example of FIG. 6, preferably, the two positioning marks M are provided on a straight line L parallel to the long sides e1 and e3 of the nozzle plate 21. In this case, at the time of positioning with the nozzle plate 21 having a long side and a short side each abutting on a jig, since the two positioning marks M are located on the straight line L parallel to the long side, the parallelism of the nozzle plate 21 to each jig can be easily grasped from the orientation of the straight line L passing through the positioning marks M, thereby facilitating positioning between stack members including the nozzle plate 21.

In addition, in order to improve the accuracy of positioning between stack members, as in the example of FIG. 6, preferably, the two positioning marks M are provided at the central position in the direction in which the short sides e2 and e4 of the nozzle plate 21 extend (in the Y direction in the drawing). In this case, the balance between the positions of both ends in the longitudinal direction of a stack member (in the X direction in the drawing) can be easily adjusted, leading to an improvement in the accuracy of positioning.

Note that, referring to FIGS. 5 and 6, the positioning marks M are circular in shape, but the shapes of the positioning marks M are not limited to a circle and thus may be a polygon, such as a triangle, a quadrangle, or a pentagon, or may be other shapes.

Next, other embodiments of the present disclosure will be described. Description of differences from the first embodiment of the present disclosure will be mainly given in the following description and description of similarities will be omitted as appropriate.

### Second Embodiment of Present Disclosure

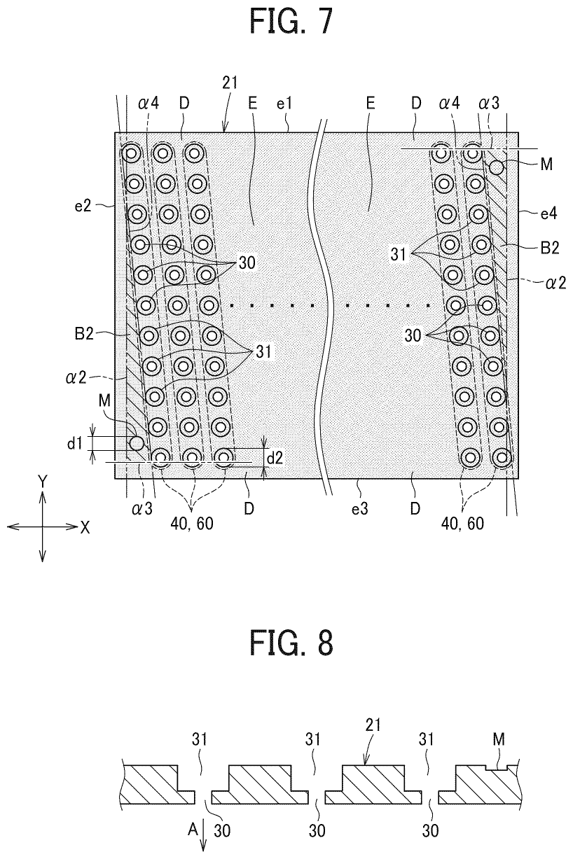

FIG. 7 is a plan view of a nozzle plate 21 according to a second embodiment of the present disclosure. FIG. 8 is a cross-sectional view of the nozzle plate 21 according to the second embodiment of the present disclosure.

According to the second embodiment of the present disclosure illustrated in FIG. 7, the nozzle plate 21 includes multiple nozzles 30 and multiple individual liquid chambers 31 in one-to-one communication with the multiple nozzles 30. That is, in this case, as in FIG. 8, each nozzle 30 and the corresponding individual liquid chamber 31 are integrally formed in the nozzle plate 21. Note that an arrow A in FIG. 8 indicates a discharging direction in which liquid is discharged through a nozzle 30.

As in FIG. 7, the individual liquid chambers 31 are each provided overlapping the corresponding nozzle 30 in view in the direction orthogonal to the joint face of the nozzle plate 21. Thus, similarly to nozzle arrays 40, liquid chamber arrays 60 are disposed obliquely with respect to the short sides e2 and e4 of the nozzle plate 21, in which the liquid chamber arrays 60 each include multiple individual liquid chambers 31.

In this case, the individual liquid chambers 31 are each formed larger than the corresponding nozzle 30 in view in the direction orthogonal to the joint face of the nozzle plate 21. Thus, a positioning mark M is to be provided out of any individual liquid chamber 31 such that the function of any individual liquid chamber 31 is not adversely affected.

Thus, according to the second embodiment of the present disclosure, positioning marks M are provided one-to-one within right-angled triangular areas B2 out of an area E in which the nozzles 30 and the individual liquid chambers 31 are disposed and the edge D of the nozzle plate 21 on the nozzle plate 21. In other words, in a case where a tangent line α4 in contact with the multiple individual liquid chambers 31 included in the liquid chamber array 60 closest to one of the short sides e2 and e4 as a pair of outer ends of the nozzle plate 21 from the side on which the corresponding short side e2 or e4 is located is defined as a “fourth tangent line”, the positioning marks M are each provided within an area B2 surrounded by the fourth tangent line α4, a second tangent line α2, and a third tangent line α3 in view in the direction orthogonal to the joint face. Note that the second tangent line α2 and the third tangent line α3 are identical to the second tangent line α2 and the third tangent line α3 in the first embodiment of the present disclosure (refer to FIG. 5).

As above, according to the second embodiment of the present disclosure, the positioning marks M are provided one-to-one to free spaces in which no nozzles 30 and no individual liquid chambers 31 are disposed (right-angled triangular areas B2) such that the positioning marks M have no influence on the nozzles 30 and the individual liquid chambers 31 and the free spaces can be effectively used as arrangement spaces for the positioning marks M. Thus, the positioning marks M can be provided without an increase in the outer dimensions of the nozzle plate 21.

At the time of formation of the individual liquid chambers 31 to the nozzle plate 21, the positioning marks M can be formed together with the individual liquid chambers 31 by etching processing (recessing processing). However, in a case where the positioning marks M are formed too large, the positioning marks M are each close to an individual liquid chamber 31. Thus, the shapes of each positioning mark M and the corresponding individual liquid chamber 31 may distort. Thus, as in FIG. 7, the positioning marks M are each preferably smaller in shape than an individual liquid chamber 31 (d1<d2) in view in the direction orthogonal to the joint face. In addition, at the time of etching processing for the positioning marks M together with the individual liquid chambers 31, in a case where the positioning marks M are small, the depths thereof are shallow. Thus, a reduction can be made in the influence on the corresponding nozzles 30 (in the distortion of the corresponding nozzles 30) due to formation of the positioning marks M.

### Third Embodiment of Present Disclosure

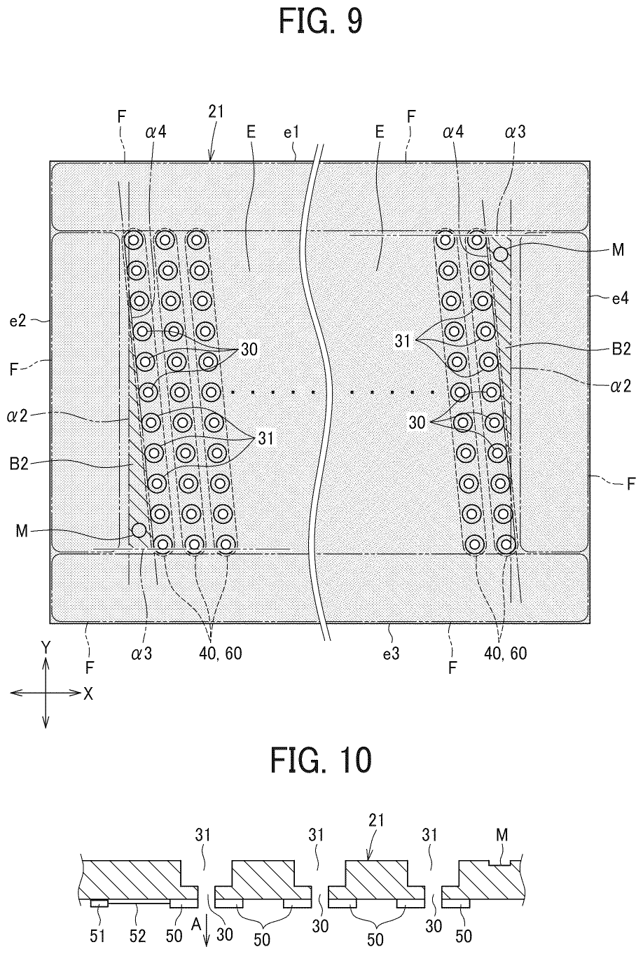

FIG. 9 is a plan view of a nozzle plate 21 according to a third embodiment of the present disclosure. FIG. 10 is a cross-sectional view of the nozzle plate 21 according to the third embodiment of the present disclosure.

According to the third embodiment of the present disclosure illustrated in FIG. 9, the nozzle plate 21 has a mount area F in which a driving circuit 51 and wiring 52 are mounted (refer to FIG. 10).

Specifically, as in FIG. 10, the nozzle plate 21 has a nozzle face (lower face in the drawing) that faces in a liquid discharge direction A and is provided with actuators 50 that each cause liquid discharging through a nozzle 30, the driving circuit 51 that drives the actuators 50, and the wiring 52 connected to the driving circuit 51. The area in which the driving circuit 51 and the wiring 52 are mounted on the nozzle plate 21 corresponds to the mount area F of FIG. 9.

The actuators 50 are each, for example, a piezoelectric element disposed around multiple nozzles 30. In response to application of a driving waveform from the driving circuit 51 to an actuator 50 through the wiring 52, the actuator 50 drives to cause displacement of the wall around a nozzle 30 (nozzle plate 21) in the liquid discharge direction A and in the direction counter to the liquid discharge direction A, so that the liquid is discharged through the nozzle 30. Note that, as such an actuator 50, instead of an electromechanical conversion element, such as a piezoelectric element, a thermomechanical conversion element, such as a bimetal, may be used.

In such a configuration having the mount area F, a positioning mark M is to be disposed out of the mount area F such that the functions of the driving circuit 51 and the wiring 52 are not adversely affected. Thus, according to the third embodiment of the present disclosure, positioning marks M are each provided without overlapping the mount area F in view in the direction orthogonal to the joint face of the nozzle plate 21. Similarly to the second embodiment of the present disclosure, according to the third embodiment of the present disclosure, each nozzle 30 and the corresponding individual liquid chamber 31 are integrally formed in the nozzle plate 21, and thus the positioning marks M are each provided not only out of the mount area F but also out of an area E in which the nozzles 30 and the individual liquid chambers 31 are disposed. Therefore, the positioning marks M are provided one-to-one within right-angled triangular areas B2 in FIG. 9 out of the area E in which the nozzles 30 and the individual liquid chambers 31 are disposed and the mount area F in which the driving circuit 51 and the wiring 52 are mounted.

As above, according to the third embodiment of the present disclosure, free spaces (right-angled triangular areas B2) in which any of the nozzles 30, the individual liquid chambers 31, the driving circuit 51, and the wiring 52 is not disposed are effectively used as arrangement spaces for the positioning marks M. Thus, the positioning marks M can be provided without an increase in the outer dimensions of the nozzle plate 21.

Although each embodiment of the present disclosure has been described above, the present disclosure is not limited to the above-described liquid discharge heads and thus can be widely applied, provided that nozzle arrays are disposed obliquely with respect to an outer end of a nozzle plate. That is, in a case where nozzle arrays are arrayed obliquely with respect to an outer end of a nozzle plate, a right-angled triangular free space is generated between the outer end of the nozzle plate and a nozzle array. Then, due to effective use of the free space as an arrangement space for a positioning mark, the positioning mark can be provided without an increase in the outer dimensions of the nozzle plate. Therefore, the present disclosure is not limited to such a configuration in which nozzle arrays are disposed obliquely with respect to a short side of a nozzle plate as in the above-described embodiments and thus can be also applied to a configuration in which nozzle arrays are disposed obliquely with respect to a long side of a nozzle plate.

In addition, the present disclosure can be also applied to such a configuration in which a positioning mark (alignment mark) is provided to a stack member different from a nozzle plate as in Japanese Unexamined Patent Application Publication No. 2004-98498.

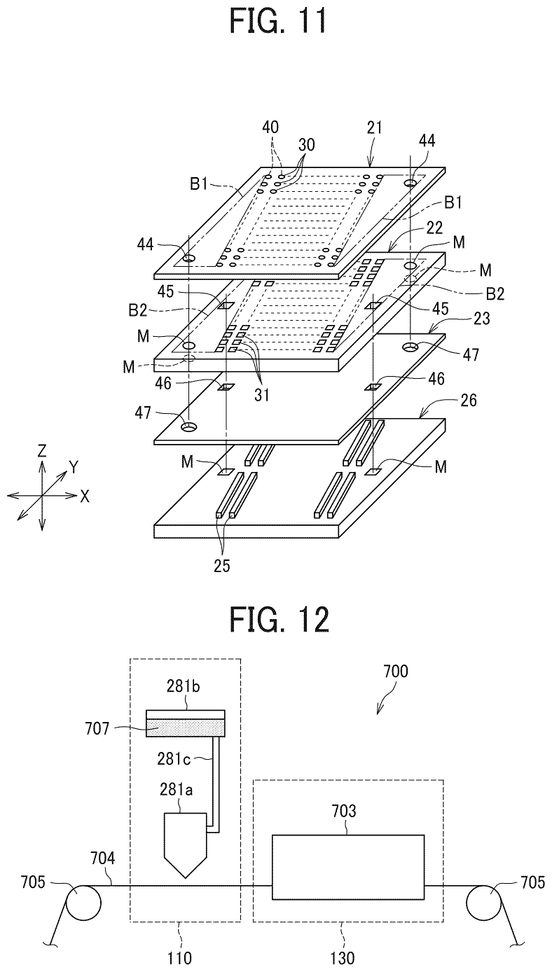

For example, as in FIG. 11, for a configuration in which positioning marks M are provided to a liquid chamber member 22 and a base member 26, provided that nozzle arrays 40 are disposed obliquely with respect to an outer end of a nozzle plate 21, such positioning marks M are provided within a right-angled triangular free space (area B1) formed between a nozzle array 40 and the outer end in view in the direction orthogonal to the joint face of the nozzle plate 21 (in the Z direction in FIG. 11). Thus, the positioning marks M can be provided without increases in the outer dimensions of the liquid chamber member 22 and the base member 26. Note that the expression “right-angled triangular free space (area B1)” means an area identical to each area B1 illustrated in FIG. 5.

Similarly to the positioning marks M, a positioning window 44 for the nozzle plate 21, a positioning window 45 for the liquid chamber member 22, and positioning windows 46 and 47 for a diaphragm 23 are provided preferably within the right-angled triangular free space (area B1). Thus, the positioning windows 44, 45, 46, and 47 can be provided without increases in the outer dimensions of stack members. In particular, in the liquid chamber member 22, the positioning mark M and the positioning window 45 are provided preferably within a right-angled triangular free space (area B2) out of an area in which individual liquid chambers 31 are disposed such that the positioning mark M and the positioning window 45 have no adverse effect on the function of the individual liquid chambers 31. Note that the expression “right-angled triangular free space (area B2)” means an area identical to each area B2 illustrated in FIG. 7.

A liquid discharge head and a liquid discharge head unit mounted on an image forming apparatus as an exemplary liquid discharge apparatus have been described as an example in the first embodiment, but a liquid discharge head and a liquid discharge head unit according to the present disclosure may be mounted on other liquid discharge apparatuses.

For example, a liquid discharge head and a liquid discharge head unit according to the present disclosure may be mounted on an electrode manufacturing apparatus that discharges a liquid composition to manufacture an electrode. An exemplary electrode manufacturing apparatus to which the present disclosure can be applied will be described below.

### Configuration of Electrode Manufacturing Apparatus

FIG. 12 is a schematic diagram illustrating the entire configuration of an electrode manufacturing apparatus 700 to which the present disclosure can be applied.

The electrode manufacturing apparatus 700 serves as a manufacturing apparatus that forms an electrode composite layer containing an active material onto an electrode substrate (current collector). The electrode composite layer is used, for example, as a constituent of an electrochemical element. As constituents other than the electrode composite layer in the electrochemical element, any publicly known constituents can be selected as appropriate without any particular limitation. Examples of constituents other than the electrode composite layer include a positive electrode, a negative electrode, and a separator.

The electrode manufacturing apparatus 700 illustrated in FIG. 12 includes a discharge process device 110 and a heating process device 130. The discharge process device 110 performs a process of applying a liquid composition for manufacturing an electrode onto a print base material 704 having a discharge target to form a liquid composition layer. The heating process device 130 performs a heating process of heating the liquid composition layer to obtain an electrode composite layer.

The electrode manufacturing apparatus 700 includes a conveyor 705 that conveys the print base material 704. The conveyor 705 conveys the print base material 704 to the discharge process device 110 and the heating process device 130 in sequence at a preset speed. A method for producing the print base material 704 having the discharge target such as an active material layer is not limited to any particular method, and thus a publicly known method can be selected as appropriate. The discharge process device 110 includes a liquid discharge head 281a that performs an application process of applying the liquid composition onto the print base material 704, a storage container 281b that stores a liquid composition 707, and a supply tube 281c that supplies the liquid composition 707 stored in the storage container 281b to the liquid discharge head 281a.

The discharge process device 110 discharges the liquid composition 707 from the liquid discharge head 281a, so that the liquid composition 707 is applied onto the print base material 704 to form a liquid composition layer in a thin film. Note that the storage container 281b may be integrated with the electrode manufacturing apparatus 700 or may be detachable from the electrode manufacturing apparatus 700. The storage container 281b may be a container additionally attachable to a storage container integrated with the electrode manufacturing apparatus 700 or to a storage container detachable from the electrode manufacturing apparatus 700.

As the storage container 281b and the supply tube 281c, any storage container and supply tube can be freely selected, provided that the liquid composition 707 can be stably stored and supplied.

The heating process device 130 performs a solvent removal process of heating and removing the solvent remaining in the liquid composition layer. Specifically, the solvent remaining in the liquid composition layer is heated and dried by a heater 703 in the heating process device 130, so that the solvent is removed from the liquid composition layer. Thus, the electrode composite layer is formed. The heating process device 130 may perform the solvent removal process under reduced pressure.

The heater 703 is not limited to any particular heater, and thus any heater can be selected as appropriate depending on the purpose.

Examples of the heater 703 include a substrate heater, an infrared (IR) heater, and a warm air heater.

The heater 703 may be a combination of at least two of the substrate heater, the IR heater, and the warm air heater. The temperature of heating and the duration of heating can be selected as appropriate in accordance with the boiling point of the solvent contained in the liquid composition 707 or the thickness of a formed film.

As the target (discharge target) to which the liquid composition is discharged, any target can be selected as appropriate depending on the purpose without any particular limitation, provided that a layer containing an electrode material can be formed onto the target. Examples of the target include an electrode substrate (current collector), an active material layer, and a layer containing a solid electrode material.

The target may be an electrode composite layer containing an active material on an electrode substrate (current collector). Provided that a layer containing an electrode material can be formed onto the target (discharge target), a discharger and a discharge process for directly discharging the liquid composition to form a layer containing an electrode material may be adopted. A discharger and a discharge process for indirectly discharging the liquid composition to form a layer containing an electrode material may be adopted.

In addition, the present disclosure can be widely applied to not only a liquid discharge apparatus that discharges liquid to a target, such as a sheet or an electrode substrate, but also a liquid discharge apparatus that discharges liquid to an object (target) to which liquid can adhere at least temporarily. Examples of a target to which liquid is discharged include a sheet, a resin film, wallpaper, and an electronic substrate. Examples of the material of a target to which liquid is discharged include paper, leather, metal, plastic, glass, wood, and ceramics.

The liquid to be discharged by a liquid discharge apparatus according to the present disclosure is not limited to any particular liquid, and thus examples thereof include solutions, suspensions, and emulsions containing water, solvents such as organic solvents, colorants such as dyes and pigments, function-imparting materials such as polymerizable compounds, resins, and surfactants, biocompatible materials such as deoxyribonucleic acid (DNA), amino acids, proteins, and calcium, and edible materials such as natural pigments. For example, such a solution, a suspension, or an emulsion can be used for inkjet ink, a surface treatment solution, a liquid for forming a constituent element for an electronic element or light-emitting element or a resist pattern for an electronic circuit, or a material solution for three-dimensional fabrication.

A liquid discharge head includes a nozzle plate (21) having a rectangular shape having long sides (e1, e3) and short sides (e2, e4); a nozzles array (40) having nozzles (30) to discharge liquid; and a positioning mark (M). The nozzles (30) in the nozzle array (40) are arrayed in a nozzle array direction oblique to one of the short sides (e2) of the nozzle plate (21). The positioning mark (M) is disposed in a positioning area (B1) having a right-angled triangular shape enclosed by the nozzle array (40), the one of the short sides (e2), and a part of one of the long sides (e3) between the one of the short sides (e2) and the nozzle array (40).

The liquid discharge head further includes multiple nozzle arrays (40) including the nozzle array (40); and multiple positioning areas (B1) having the positioning area (B1). The multiple nozzle array (40) is arrayed in a longitudinal direction (X) of the nozzle plate (21) parallel to the long sides (e1, e3) of the nozzle plate (21). The multiple positioning areas (B1) is disposed at each end of the nozzle plate in the longitudinal direction.

The nozzle array has a first nozzle (30a) at one end of the nozzle array (40) and closest to the one of the short ends (e2) of the nozzles (30) in the longitudinal direction; and a second nozzle (30b) at another end of the nozzle array (40) and farthest from the one of the short ends (e2) of the nozzles (30) ) in the longitudinal direction. The positioning area is enclosed by: a first tangent line (α1) along the nozzle array (40) from the first nozzle (30a) to the second nozzle (30b) in the nozzle array direction; a second tangent line (α2) extending parallel to the one of the short sides (e2) from the first nozzle (30a) to the second nozzle in a transverse direction orthogonal to the longitudinal direction; and a third tangent line (α3) extending parallel to the one of the long sides (e3) in the longitudinal direction, from the second nozzle (30b) to an intersection point of the second tangent line (α2) and the third tangent line (α3).

The liquid discharge head further includes a channel plate (22) stacked on and joined to the nozzle plate (21), a diaphragm (23) stacked on and joined to the channel plate (22), and a base plate (24) stacked on and joined to the diaphragm (23). The channel plate (22) includes liquid chamber arrays including liquid chambers (31) respectively communicating with the nozzles (30). The diaphragm (23) faces the liquid chambers (31) to displace and discharge the liquid in the liquid chambers (31) from the nozzles (30). Each of the channel plate (22) and the diaphragm (23) has the positioning mark (M) disposed at an identical position in the longitudinal direction and the transverse direction.

The positioning mark has a hole (41, 42, 43) penetrating through the nozzle plate, the channel plate, and the diaphragm staked with each other.

The liquid chambers (31) respectively overlap the nozzles in a plan view of the nozzle plate joined to the channel plate. Each of the liquid chambers (31) has a first area larger than a second area of each of the nozzles in a plan view of the nozzle plate joined to the channel plate. The liquid chamber arrays are arrayed in the nozzle array direction. The positioning mark (M) is disposed in a positioning area (B2) having a right-angled triangular shape enclosed by a fourth tangent line (α4), the second tangent line (α2), and the third tangent line (α3). The fourth tangent line (α4) is along an outer periphery of the liquid chambers (31) of the liquid chamber array (60) closest to the one of the short sides (e2).

The positioning mark is smaller than each of the multiple individual liquid chambers in a plan view of the nozzle plate.

The liquid discharge head further includes two positioning marks having the positioning mark. The two positioning areas has the positioning area. The two positioning marks are arranged at the diagonal corners of the rectangular shape of the nozzle plate. The two positioning areas, each having right-angled triangular shape, are arranged symmetrically at each end of the nozzle plate in the longitudinal direction.

The positioning mark is disposed at a center between the first tangent line and the second tangent line in the transverse direction.

The liquid discharge head further includes an actuator to displace the diaphragm; a drive circuit to drive the actuator; and wiring connected to the drive circuit. The base plate has a mount area to mount the actuator, the driving circuit, and the wiring, and the positioning mark is disposed outside the mount area in a plan view of the base plate.

A liquid discharge head unit includes multiple liquid discharge heads including the liquid discharge head.

A liquid discharge apparatus includes the liquid discharge head.

As aspects of the present disclosure described above, at least the following aspects are included in the present disclosure.

### Aspect 1

According to Aspect 1, a liquid discharge head includes: a nozzle plate including nozzle arrays disposed obliquely with respect to an outer end of the nozzle plate, the nozzle arrays each including multiple nozzles arrayed, the multiple nozzles being to discharge liquid; multiple stack members including the nozzle plate, the multiple stack members being joined together in a stack; and a positioning mark provided within an area of at least one of the multiple stack members in order to position the multiple stack members, in which a tangent line in contact with the multiple nozzles included in a nozzle array closest to the outer end among the nozzle arrays from a side on which the outer end is located is defined as a first tangent line, a tangent line that is in contact with a nozzle closest to the outer end among the multiple nozzles included in the nozzle array closest to the outer end among the nozzle arrays from the side on which the outer end is located and is parallel to the outer end is defined as a second tangent line, a tangent line that is in contact with a nozzle farthest from the outer end among the multiple nozzles included in the nozzle array closest to the outer end among the nozzle arrays from outside the nozzle array and is orthogonal to the outer end is defined as a third tangent line, and the area is surrounded by the first tangent line, the second tangent line, and the third tangent line in view in a direction orthogonal to a joint face between the multiple stack members joined.

### Aspect 2

According to Aspect 2, in the liquid discharge head of Aspect 1, the nozzle plate includes liquid chamber arrays disposed obliquely with respect to the outer end of the nozzle plate, the liquid chamber arrays following the nozzle arrays, the liquid chamber arrays corresponding one-to-one to the nozzle arrays, the liquid chamber arrays each including multiple individual liquid chambers arrayed, the multiple individual liquid chambers being in one-to-one communication with the multiple nozzles of the corresponding nozzle array, each of the multiple individual liquid chambers is larger than the corresponding nozzle and is provided overlapping the corresponding nozzle in view in the direction orthogonal to the joint face, a tangent line in contact with the multiple individual liquid chambers included in a liquid chamber array closest to the outer end among the liquid chamber arrays from the side on which the outer end is located is defined as a fourth tangent line, and the positioning mark is provided within an area surrounded by the fourth tangent line, the second tangent line, and the third tangent line in view in the direction orthogonal to the joint face.

### Aspect 3

According to Aspect 3, in the liquid discharge head of Aspect 2, the positioning mark is smaller than each of the multiple individual liquid chambers in view in the direction orthogonal to the joint face.

### Aspect 4

According to Aspect 4, in the liquid discharge head of any one of Aspects 1 to 3, the nozzle plate includes a rectangular plate-like member having outer ends including a long side and a short side orthogonal to each other, the positioning mark includes two positioning marks provided separately from each other in a direction in which the long side extends, and the two positioning marks are provided on a straight line parallel to the long side.

### Aspect 5

According to Aspect 5, in the liquid discharge head of Aspect 4, the two positioning marks are provided at a central position in a direction in which the short side extends.

### Aspect 6

According to Aspect 6, in the liquid discharge head of any one of Aspects 1 to 5, the nozzle plate includes a mount area in which a driving circuit that drives an actuator for discharging the liquid through each of the multiple nozzles and wiring are mounted, and the positioning mark is provided out of the mount area in view in the direction orthogonal to the joint face.

### Aspect 7

According to Aspect 7, a liquid discharge head unit includes multiple the liquid discharge heads of any one of Aspects 1 to 6.

### Aspect 8

According to Aspect 8, a liquid discharge apparatus for discharging liquid to a target includes the liquid discharge head of any one of Aspects 1 to 6 or the liquid discharge head unit of Aspect 7.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a nozzle plate having:
a rectangular shape having long sides and short sides;
a nozzles array having nozzles to discharge liquid,
the nozzles in the nozzle array arrayed in a nozzle array direction oblique to one of the short sides of the nozzle plate; and
a positioning mark disposed in a positioning area having a right-angled triangular shape enclosed by:
the nozzle array;
the one of the short sides; and
a part of one of the long sides between the one of the short sides and the nozzle array.

2. The liquid discharge head according to claim 1, further comprising:
multiple nozzle arrays including the nozzle array,
the multiple nozzle array arrayed in a longitudinal direction of the nozzle plate parallel to the long sides of the nozzle plate; and
multiple positioning areas having the positioning area,
the multiple positioning areas disposed at each end of the nozzle plate in the longitudinal direction.

3. The liquid discharge head according to claim 1, wherein:
the nozzle array has:
a first nozzle at one end of the nozzle array and closest to the one of the short sides of the nozzles in a longitudinal direction of the nozzle plate parallel to the long sides of the nozzle plate; and
a second nozzle at another end of the nozzle array and farthest from the one of the short sides of the nozzles in the longitudinal direction; and
the positioning area is enclosed by:
a first tangent line along the nozzle array from the first nozzle to the second nozzle in the nozzle array direction;
a second tangent line extending parallel to the one of the short sides from the first nozzle to the second nozzle in a transverse direction orthogonal to the longitudinal direction; and
a third tangent line extending parallel to the one of the long sides in the longitudinal direction, from the second nozzle to an intersection point of the second tangent line and the third tangent line.

4. The liquid discharge head according to claim 3, further comprising:
a channel plate stacked on and joined to the nozzle plate,
the channel plate including liquid chamber arrays including liquid chambers respectively communicating with the nozzles;
a diaphragm stacked on and joined to the channel plate,
the diaphragm facing the liquid chambers to displace and discharge the liquid in the liquid chambers from the nozzles; and
a base plate stacked on and joined to the diaphragm, wherein:
each of the channel plate and the diaphragm has the positioning mark disposed at an identical position in the longitudinal direction and the transverse direction.

5. The liquid discharge head according to claim 4, wherein:
the positioning mark has a hole penetrating through the nozzle plate, the channel plate, and the diaphragm staked with each other.

6. The liquid discharge head according to claim 4, wherein:
the liquid chambers respectively overlap the nozzles in a plan view of the nozzle plate joined to the channel plate,
each of the liquid chambers has a first area larger than a second area of each of the nozzles in a plan view of the nozzle plate joined to the channel plate,
the liquid chamber arrays are arrayed in the nozzle array direction,
the positioning mark is disposed in a positioning area having a right-angled triangular shape enclosed by a fourth tangent line, the second tangent line, and the third tangent line, and
the fourth tangent line is along an outer periphery of the liquid chambers of the liquid chamber array closest to the one of the short sides.

7. The liquid discharge head according to claim 5, wherein:
the positioning mark is smaller than each of the liquid chambers in a plan view of the nozzle plate.

8. The liquid discharge head according to claim 1, further comprising:
two positioning marks having the positioning mark; and
two positioning areas having the positioning area, wherein:
the two positioning marks are arranged at diagonal corners of the rectangular shape of the nozzle plate, and
the two positioning areas each having right-angled triangular shape are arranged symmetrically at each end of the nozzle plate in a longitudinal direction of the nozzle plate parallel to the long sides of the nozzle plate.

9. The liquid discharge head according to claim 4, wherein:
the positioning mark is disposed at a center between the first tangent line and the second tangent line in the transverse direction.

10. The liquid discharge head according to claim 4, further comprising:
an actuator to displace the diaphragm;
a drive circuit to drive the actuator; and
wiring connected to the drive circuit, wherein:
the base plate has a mount area to mount the actuator, the driving circuit, and the wiring, and
the positioning mark is disposed outside the mount area in a plan view of the base plate.

11. A liquid discharge head unit comprising multiple liquid discharge heads including the liquid discharge head according to claim 1.

12. A liquid discharge apparatus comprising the liquid discharge head according to claim 1.
